(19) United States
(12) Patent Application Publication
(10) Pub. No.: US 2026/0073532 A1
(43) Pub. Date: Mar. 12, 2026

(54) IMAGE QUALITY IMPROVEMENT METHOD AND SURVEILLANCE SYSTEM

(71) Applicant: VIVOTEK INC., New Taipei City (TW)

(72) Inventors: Peng-Feng Kao, New Taipei City (TW); Chang-Lin Li, New Taipei City (TW)

(73) Assignee: VIVOTEK INC., New Taipei City (TW)

(21) Appl. No.: 19/309,643

(22) Filed: Aug. 26, 2025

(30) Foreign Application Priority Data
Sep. 12, 2024 (TW) 113134661

(51) Int. Cl. G06T 7/246; G06T 7/73; G06V 20/52; H04N 7/18; H04N 23/56

(52) U.S. Cl. CPC G06T 7/246; G06T 7/73; G06V 20/52; H04N 7/18; H04N 23/56; G06T 2207/10016; G06T 2207/10024; G06T 2207/30196

(57) ABSTRACT

An image quality improvement method is applied to an operation processor of a surveillance system and includes driving a first light source of the surveillance system to emit a first illumination beam, driving an image camera of the surveillance system to capture a first image relevant to the first illumination beam, and deciding whether to drive a second light source of the surveillance system to emit a second illumination beam and/or decide an illumination intensity of the second illumination beam in accordance with an analysis result of the first image.

### BACKGROUND OF THE INVENTION

### 1. Field of the Invention

The present invention relates to an image quality improvement method and a related surveillance system, and more particularly, to an image quality improvement method of avoiding image overexposure and a related surveillance system.

### 2. Description of the Prior Art

A conventional surveillance camera is used in the public place, such as the road and the square, as well as in the private place, such as the factory, residence, and the shop. The surveillance camera performs an image surveillance function both during the day and at night. When the surveillance camera is in a low-light environment, the light source must be activated to enhance illumination for capturing the clear and detailed surveillance image. However, sudden changes in the ambient brightness may cause glare and other visual discomfort to the human (e.g., the moving object); in addition, because the light source does not adaptively adjust the illumination intensity, the surveillance image captured by the surveillance camera may often be overexposed. The foresaid drawbacks are particularly prone to occur at night or in the low-light environment, not only causing discomfort to the person, but also preventing the surveillance camera from capturing the clear image, thereby compromising its intended surveillance function. Design of a surveillance system that can adaptively activate and adjust the light source is an important issue in the surveillance industry.

### SUMMARY OF THE INVENTION

The present invention provides an image quality improvement method of avoiding image overexposure and a related surveillance system for solving above drawbacks.

According to one embodiment, an image quality improvement method is applied to an operation processor of a surveillance system. The image quality improvement method includes driving a first light source of the surveillance system to emit a first illumination beam, driving an image camera of the surveillance system to capture a first image relevant to the first illumination beam, and deciding whether to drive a second light source of the surveillance system to emit a second illumination beam and/or decide an illumination intensity of the second illumination beam in accordance with an analysis result of the first image. The first illumination beam of the first light source and the second illumination beam of the second light source have different wavelength ranges.

According to another embodiment, a surveillance system includes a first light source, a second light source, an image camera and an operation processor. The first light source is adapted to emit a first illumination beam. The second light source is adapted to emit a second illumination beam having a wavelength range different from a wavelength range of the first illumination beam. The image camera has an imaging range relevant to the first light source and the second light source. The operation processor is electrically connected to the first light source and the second light source and the image camera. The operation processor is adapted to drive the first light source to emit a first illumination beam, drive the image camera to capture a first image relevant to the first illumination beam, and decide whether to drive the second light source to emit a second illumination beam and/or decide an illumination intensity of the second illumination beam in accordance with an analysis result of the first image.

The image quality improvement method and the surveillance system of the present invention can utilize the first light source and second light source to respectively provide different types of illumination (e.g., the invisible illumination and visible illumination). When the surveillance system is in the low-light environment, the surveillance system can drive the first light source to emit the invisible light, and the image camera can capture and analyze the image illuminated by the invisible light without disturbing people around, thereby finding whether the target object (e.g., the object being captured) is in the surveillance region. When the moving path of the target object is determined to enter the illumination range of the second light source (e.g., the visible light source), the image quality improvement method can drive the second light source to emit the visible light, and further can gradually increase the illumination intensity of the visible illumination in accordance with the moving path of the target object, thereby preventing the glare caused by the target object being illuminated by the visible light with highest intensity as soon as the target object just enters the illumination range of the visible light to cause discomfort to the target object.

The image quality improvement method and the surveillance system of the present invention can further find out the feature region of the target object. (e.g., the face of the person being captured), and determine position of the feature region inside the illumination range of the visible light (e.g., the central illumination region or the peripheral illumination region in the illumination range), so as to adaptively adjust the second light source to provide the visible illumination at the optimal illumination intensity. The present invention can effectively avoid overexposure of the feature region of the target object captured in the second image, and therefore the second image can provide the clear face image. Besides, the present invention can analyze the image of the target object illuminated by the invisible light emitted by the first light source to confirm or predict the moving path and position of the target object, which serves as a reference for determining activation of the second light source and the related illumination intensity. Therefore, the foresaid property of the present invention can significantly reduce the response time of activation of the second light source and acquire the optimal illumination intensity of the second light source corresponding to the target object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a surveillance system according to an embodiment of the present invention.

FIG. 2 is an application diagram of the surveillance system according to the embodiment of the present invention.

FIG. 3 is a flow chart of the image quality improvement method according to the embodiment of the present invention.

### DETAILED DESCRIPTION

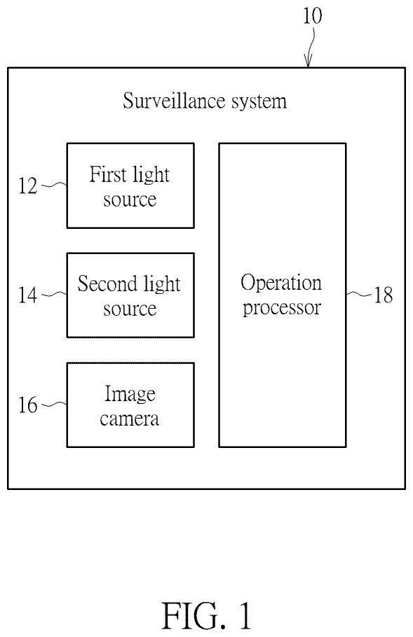

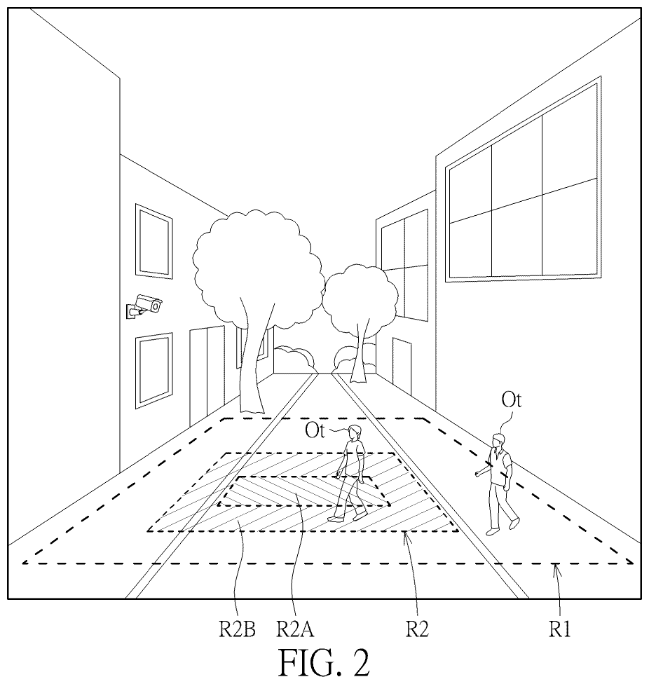

Please refer to FIG. 1 and FIG. 2. FIG. 1 is a functional block diagram of a surveillance system 10 according to an embodiment of the present invention. FIG. 2 is an application diagram of the surveillance system 10 according to the embodiment of the present invention. The surveillance system 10 can be a surveillance camera installed in the private place or the public place for 24/7 surveillance. The surveillance system 10 can have a visible light source and an invisible light source. The visible light source can illuminate a surveillance range in a low-light environment. The invisible light source can provide auxiliary illumination for the surveillance system 10 at night to avoid disturbing other persons. However, the visible light source can be automatically activated when a moving object is detected within the surveillance range, and illumination intensity of the visible light source can be adaptively adjusted according to a distance of the moving object relative to the surveillance system 10 within the surveillance range, thereby acquiring a clear and bright surveillance image.

The surveillance system 10 can at least include a first light source 12, a second light source 14, an image camera 16 and an operation processor 18. The first light source 12 can emit a first illumination beam, and can be the invisible light source. The second light source 14 can emit a second illumination beam having a wavelength range different from a wavelength range of the first illumination beam, and can be a visible light source. An imaging range of the image camera 16 can cover an area illuminated by the illumination beams of the first light source 12 and the second light source 14. The operation processor 18 can be electrically connected to the first light source 12, the second light source 14 and the image camera 16, and can execute an image quality improvement method of the present invention.

The first light source 12 can emit the first illumination beam to form a first illumination range R1. The second light source 14 can project the second illumination beam to form a second illumination range R2. The first illumination range R1 can be greater than and overlapped with the second illumination range R2. It should be mentioned that the first illumination beam and the second illumination beam can be divergence beams, so the first illumination range R1 and the second illumination range R2 are approximate ranges. In some possible situations, the first illumination beam may be emitted outside the first illumination range R1, and the second illumination beam may be emitted outside the second illumination range R2.

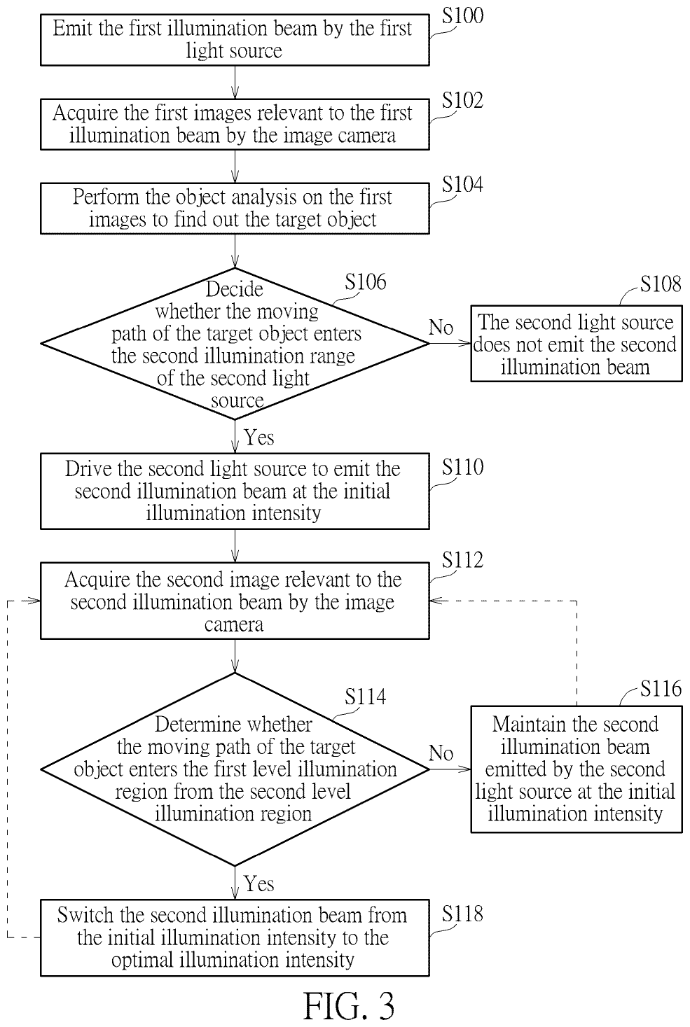

Please refer to FIG. 3. FIG. 3 is a flow chart of the image quality improvement method according to the embodiment of the present invention. The image quality improvement method illustrated in FIG. 3 can be suitable for the surveillance system 10 shown in FIG. 1. Regarding the image quality improvement method, step S100, step S102 and step S104 can be executed to emit the first illumination beam by the first light source 12, continuously acquire a plurality of first images relevant to the first illumination beam by the image camera 16, and perform object analysis on the plurality of first images to find out a target object Ot within the first illumination range R1. In step S104, the object analysis can search coordinate change of the target object Ot within the plurality of first images, and determine a moving direction and a moving speed of the target object Ot based on the coordinate change, so as to acquire an actual moving path (e.g., a historical path) and an estimated moving path (e.g., a predicted path) of the target object Ot.

Position of the first light source 12 and the second light source 14 are fixed, and the first illumination range R1 and the second illumination range R2 are known ranges, so that step S106 can be executed to decide whether a moving path of the target object Ot enters the second illumination range R2. The foresaid moving path can be selected from a group consisting of the actual moving path (e.g., the historical path), the estimated moving path (e.g., the predicted path), and a combination thereof. If the target object Ot does not enter the second illumination range R2, step S108 can be executed that the first light source 12 can still emit the first illumination beam (e.g., the invisible light), and the second light source 14 does not emit the second illumination beam (e.g., the visible light); in the meantime, the first illumination beam (e.g., the invisible light) can be the illumination light source of the image camera 16. If the moving path of the target object Ot enters the second illumination range R2 from the first illumination range R1, step S110 and step S112 can be executed to drive the second light source 14 to emit the second illumination beam at an initial illumination intensity, and then acquire a second image relevant to the second illumination beam by the image camera 16; in the meantime, the first light source 12 can be optionally turned off. The visible light can be the illumination light source of the second image, so that the user can see the clear and discernible content in the second image.

The image quality improvement method of the present invention can further perform the object analysis on the first image to find out a feature region of the target object Ot. For example, when the target object Ot is a person, the feature region can be a face of the person; when the target object Ot is a vehicle, the feature region can be a license plate of the vehicle, but the actual application is not limited to the foresaid embodiment. In the present invention, step S106 can decide that the feature region of the target object Ot enters the second illumination range R2 from the first illumination range R1, and then step S110 can be executed to activate the second light source 14. The second light source 14 does not need to be activated until all regions of the target object Ot enter the second illumination range R2.

In the preferred embodiment of the present invention, the second illumination range R2 can be further divided into a first level illumination region R2A and a second level illumination region R2B that are not overlapped. The first level illumination region R2A can be defined as a central illumination region of the second illumination range R2, and the second level illumination region R2B can be defined as a peripheral illumination region of the second illumination range R2. The first level illumination region R2A can be surrounded by the second level illumination region R2B. In step S110, the target object Ot just enters the second illumination range R2 from the first illumination range R1, and is located inside the second level illumination region R2B. Then, step S114 can be optionally executed to continuously track the target object Ot and determine whether the moving path of the target object Ot enters the first level illumination region R2A from the second level illumination region R2B. The foresaid moving path can be selected from a group consisting of the actual moving path (e.g., the historical path), the estimated moving path (e.g., the predicted path), and a combination thereof.

If the moving path of the target object Ot does not enter the first level illumination region R2A, the target object Ot may stay or loiter in the second level illumination region R2B (e.g., the peripheral illumination region of the second illumination range R2), and step S116 can be executed to maintain the second illumination beam emitted by the second light source 14 at the initial illumination intensity. If the moving path of the target object Ot enters the first level illumination region R2A, the target object Ot should be in the first level illumination region R2A and stayed in a central field of vision or a key observation area of the surveillance range of the surveillance system 10, and step S118 can be executed to switch the second illumination beam emitted by the second light source 14 from the initial illumination intensity to an optimal illumination intensity. The image camera 16 can capture the second image with best clarity. Moreover, the illumination intensity of the second light source 14 can be gradually increased, so that the human eye may adapt to brightness of target object Ot without causing visual glare. In the possible embodiment of the present invention, the initial illumination intensity can be set to 30% of the maximum intensity, and the optimal illumination intensity can be set to the maximum intensity, but the actual application is not limited thereto.

Division of the first illumination range R1 and the second illumination range R2 in the surveillance range of the surveillance system 10 is not limited to the embodiment shown in the figures. Position, dimensions and a ratio of the first level illumination region R2A to the second level illumination region R2B within the second illumination range R2 are not limited to the embodiment shown in the figures, which can depend on a design demand. For example, the first illumination range R1 may be interpreted as a non-key area of the surveillance range, such as a sidewalk, and the second illumination range R2 may be interpreted as a key area of the surveillance range, such as a road, so the surveillance system 10 can clearly capture the surveillance image containing the pedestrian walking on the road in violation of traffic regulation. The first level illumination region R2A may be further interpreted as center of the road, and the second level illumination region R2B may be further interpreted as two sides of the road, so the surveillance system 10 can distinguish between the pedestrian walking on the road and the pedestrian crossing the road. The present invention is not limited to the above embodiments, and other possible embodiments are not described herein for simplicity.

Moreover, step S104 can perform the object analysis on the plurality of first images and/or second images to further compute height information of the target object Ot within the first image. The height information may be an overall height of the target object Ot (e.g., a body height of the person) or a position height of the human face. The image quality improvement method of the present invention can utilize the deep learning model or the machine learning model to determine possible position (which can be, but not limited to, position coordinates, a distance, an angle, and/or a height relative to the image camera 16, etc.) of the feature region of the target object Ot in accordance with the height information and the moving path of the target object Ot, and then analyze the feature region is located in the first illumination range R1 or the second illumination range R2, or located in the first level illumination region R2A or the second level illumination region R2B, so as to decide whether to emit the second illumination beam and how to adjust the illumination intensity of the second illumination beam.

Further, step S104 may compute depth information of the target object Ot within the first image and/or the second image. The depth information can be a distance of the target object Ot relative to the surveillance system 10. The image quality improvement method of the present invention can utilize the deep learning model or the machine learning model to determine the possible position of the feature region of the target object Ot in accordance with variation of the height information and the depth information of the target object Ot, thereby adjusting the illumination intensity of the second illumination beam accordingly. In addition, step S104 may further compute area information (e.g., an area size) of the feature region (e.g., the face of the person or the license plate of the vehicle) of the target object Ot within the first image and/or the second image. The illumination intensity of the second illumination beam can be accordingly adjusted based on the area information (e.g., the area size) of the feature region.

In other possible embodiment, step S104 may predict an angle (e.g., an angle of the human face towards the image camera 16) of the feature region relative to the image camera 16 via the moving path, and further compute the area information (e.g., the area size) of the feature region relative to an image field of view of the image camera 16 by combining the depth information, the position information, the height information, the area information of the feature region of the target object Ot, and a combination thereof. For example, when the feature region is the human face, the angel of the human face towards the image camera 16 can be predicted to further compute the area size of the human face within the captured image, so as to decide the illumination intensity of the second illumination beam based on the area size of the captured human face for accurate adjustment.

In conclusion, the image quality improvement method and the surveillance system of the present invention can utilize the first light source and second light source to respectively provide different types of illumination (e.g., the invisible illumination and visible illumination). When the surveillance system is in the low-light environment, the surveillance system can drive the first light source to emit the invisible light, and the image camera can capture and analyze the image illuminated by the invisible light without disturbing people around, thereby finding whether the target object (e.g., the object being captured) is in the surveillance region. When the moving path of the target object is determined to enter the illumination range of the second light source (e.g., the visible light source), the image quality improvement method can drive the second light source to emit the visible light, and further can gradually increase the illumination intensity of the visible illumination in accordance with the moving path of the target object, thereby preventing the glare caused by the target object being illuminated by the visible light with highest intensity as soon as the target object just enters the illumination range of the visible light to cause discomfort to the target object.

The image quality improvement method and the surveillance system of the present invention can further find out the feature region of the target object. (e.g., the face of the person being captured), and determine position of the feature region inside the illumination range of the visible light (e.g., the central illumination region or the peripheral illumination region in the illumination range), so as to adaptively adjust the second light source to provide the visible illumination at the optimal illumination intensity. The present invention can effectively avoid overexposure of the feature region of the target object captured in the second image, and therefore the second image can provide the clear face image. Besides, the present invention can analyze the image of the target object illuminated by the invisible light emitted by the first light source to confirm or predict the moving path and position of the target object, which serves as a reference for determining activation of the second light source and the related illumination intensity; the foresaid property of the present invention can significantly reduce the response time and acquire the optimal illumination intensity corresponding to the target object.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image quality improvement method applied to an operation processor of a surveillance system, the image quality improvement method comprising:
the operation processor driving a first light source of the surveillance system to emit a first illumination beam;
the operation processor driving an image camera of the surveillance system to capture a first image relevant to the first illumination beam; and
the operation processor deciding whether to drive a second light source of the surveillance system to emit a second illumination beam and/or decide an illumination intensity of the second illumination beam in accordance with an analysis result of the first image;
wherein the first illumination beam of the first light source and the second illumination beam of the second light source have different wavelength ranges.

2. The image quality improvement method of claim 1, wherein a first illumination range of the
first illumination beam is greater than and overlapped with a second illumination range of the second illumination beam, the image quality improvement method further comprises:
the operation processor performing object analysis on the first image to find out a target object; and
the operation processor driving the second light source to emit the second illumination beam at an initial illumination intensity when a moving path of the target object enters the second illumination range from the first illumination range.

3. The image quality improvement method of claim 2, wherein the moving path is selected from a group consisting of an actual moving path of the target object, an estimated moving path of the target object, and a combination thereof.

4. The image quality improvement method of claim 2, wherein the second illumination range
comprises a first level illumination region and a second level illumination region that are not overlapped, the image quality improvement method further comprises:
the operation processor driving the second light source to switch the second illumination beam from the initial illumination intensity to an optimal illumination intensity when the moving path of the target object enters the first level illumination region from the second level illumination region.

5. The image quality improvement method of claim 4, wherein the first level illumination region and the second level illumination region respectively are a central illumination region and a peripheral illumination region, the central illumination region is surrounded by the peripheral illumination region.

6. The image quality improvement method of claim 1, further comprising:
the operation processor computing height information and depth information of a target object within the first image; and
the operation processor adjusting the illumination intensity of the second illumination beam in accordance with variation of the height information and the depth information.

7. The image quality improvement method of claim 1, further comprising:
the operation processor computing height information of a target object within the first image;
the operation processor deciding position of a feature region of the target object in accordance with the height information and a moving path of the target object; and
the operation processor deciding the illumination intensity of the second illumination beam in accordance with the position of the feature region.

8. The image quality improvement method of claim 1, further comprising:
the operation processor computing area information of a feature region of a target object; and
the operation processor deciding the illumination intensity of the second illumination beam in accordance with the area information.

9. The image quality improvement method of claim 8, further comprising:
the operation processor computing a capturing angle of the target object relative to the image camera;
the operation processor computing the area information of the feature region based on the capturing angle; and
the operation processor deciding the illumination intensity of the second illumination beam in accordance with the area information.

10. The image quality improvement method of claim 1, wherein the first light source and the second light source respectively are an invisible light source and a visible light source.

11. A surveillance system, comprising:
a first light source adapted to emit a first illumination beam;
a second light source adapted to emit a second illumination beam having a wavelength range different from a wavelength range of the first illumination beam;
an image camera having an imaging range relevant to the first light source and the second light source; and
an operation processor electrically connected to the first light source and the second light source and the image camera, the operation processor being adapted to drive the first light source to emit a first illumination beam, drive the image camera to capture a first image relevant to the first illumination beam, and decide whether to drive the second light source to emit a second illumination beam and/or decide an illumination intensity of the second illumination beam in accordance with an analysis result of the first image.

12. The surveillance system of claim 11, wherein a first illumination range of the first illumination beam is greater than and overlapped with a second illumination range of the second illumination beam, the operation processor is adapted to further perform object analysis on the first image to find out a target object, and drive the second light source to emit the second illumination beam at an initial illumination intensity when a moving path of the target object enters the second illumination range from the first illumination range.

13. The surveillance system of claim 12, wherein the moving path is selected from a group consisting of an actual moving path of the target object, an estimated moving path of the target object, and a combination thereof.

14. The surveillance system of claim 12, wherein the second illumination range comprises a first level illumination region and a second level illumination region that are not overlapped, the operation processor is adapted to further drive the second light source to switch the second illumination beam from the initial illumination intensity to an optimal illumination intensity when the moving path of the target object enters the first level illumination region from the second level illumination region.

15. The surveillance system of claim 14, wherein the first level illumination region and the second level illumination region respectively are a central illumination region and a peripheral illumination region, the central illumination region is surrounded by the peripheral illumination region.

16. The surveillance system of claim 11, wherein the operation processor is adapted to further compute height information and depth information of a target object within the first image, and adjust the illumination intensity of the second illumination beam in accordance with variation of the height information and the depth information.

17. The surveillance system of claim 11, wherein the operation processor is adapted to further compute height information of a target object within the first image, decide position of a feature region of the target object in accordance with the height information and a moving path of the target object, and decide the illumination intensity of the second illumination beam in accordance with the position of the feature region.

18. The surveillance system of claim 11, wherein the operation processor is adapted to further compute area information of a feature region of a target object within the first image, and decide the illumination intensity of the second illumination beam in accordance with the area information.

19. The surveillance system of claim 18, wherein the operation processor is adapted to further compute a capturing angle of the target object relative to the image camera, compute the area information of the feature region based on the capturing angle, and decide the illumination intensity of the second illumination beam in accordance with the area information.

20. The image quality improvement method of claim 11, wherein the first light source and the second light source respectively are an invisible light source and a visible light source.
